(19) United States
(12) Patent Application Publication
(10) Pub. No.: US 2014/0172784 A1
(43) Pub. Date: Jun. 19, 2014

(54) INTERNET BUSINESS CARD MANAGEMENT METHOD AND SYSTEM

(71) Applicants: One Jay Choi, Seoul (KR); Dong Soo Ann, Seoul (KR)

(72) Inventors: One Jay Choi, Seoul (KR); Dong Soo Ann, Seoul (KR)

(73) Assignee: NAMEE, INC., Seoul (KR)

(21) Appl. No.: 14/125,009

(22) PCT Filed: Jun. 11, 2012
(86) PCT No.: PCT/KR2012/004605

§ 371 Date: Mar. 3, 2014

(30) Foreign Application Priority Data
Jun. 9, 2011 (KR) 10-2011-0055447

(51) Int. Cl. G06F 17/30

(52) U.S. Cl. CPC G06F 17/30289
USPC 707/609; 707/722

(57) ABSTRACT

An internet business card management method according to an embodiment of the present invention includes: maintaining a business card database for storing a business card including at least one piece of information on the name, address, contact, e-mail address, or home page of each user; detecting the occurrence of a business card exchange event between a first user and a second among the users; creating a link between the internet business card of the first user and the internet business card of the second user in response to the occurrence of the business card exchange event; and in response to a business card lookup request of the first user or the second user, displaying a user's internet business card corresponding to the request.

### TECHNICAL FIELD

Exemplary embodiments of the disclosure relate to a method and a system for managing internet business cards.

### BACKGROUND

A business card is a paper card on which a person's name, address, telephone, company name, and position in the company are printed to describe himself/herself. Generally, on a business card are printed a name and contact information. A person's duty or job and academic degree are described on a business card frequently. Also, students having no regular jobs yet use business cards (e.g., fashionable business cards)as means for expressing themselves. However, such conventional business cards have a disadvantage that new business cards have to be made in case personal information is changed, for example, contact information or the job is changed. In addition, there is another disadvantage that no further personal information about the acquaintance can be figured out or it is difficult to contact with the acquaintance in case of losing an acquaintance's business card. Accordingly, a method for managing business cards is required which can manage business cards efficiently, with overcoming the limitation such the conventional paper business cards, and maintain the equivalent of exchanging business cards between persons, using the internet used in various fields of everyday life.

### DISCLOSURE

### Technical Problem

Exemplary embodiments of the present disclosure provide a method and a system for managing business cards which can maintain human networking constantly by forming a link between internet business cards exchanged between users and providing another user's internet business card requested by a user in response to a user's business card search query.

Exemplary embodiments of the present disclosure also provide a method and a system for managing business cards which can overcome the limitations of such the conventional paper business cards by producing an internet business card or mobile business card in response to a query made by a user to produce paper business cards automatically.

### Technical Solution

To achieve these objects and other advantages and in accordance with the purpose of the invention, as embodied and broadly described herein, a method for managing internet business cards includes maintaining a business card database in which internet business cards including one or more of users' names, addresses, contact information, e-mail addresses and home page addresses; sensing a business card exchange event generated between a first user and a second user out of the users; forming a link between the first user's internet business card and the second user's business card in response to the generated business card exchange event; and displaying a corresponding user's internet business card in response to the first user's or second user's search query the business card.

The method for managing the internet business cards may further include searching the second user's updated business card on the business card database, when the first user asks to search for the second user's internet business card; and displaying the second user's updated internet business card to the first user based on the search result.

The method for managing the internet business cards may further include setting a security level for a link formed between internet business cards corresponding to each two of the users.

The method for managing the internet business cards may further include selecting one or more of information pieces which will be released according to the set security level; and providing the selected information to users whose internet business cards are linked with each other.

The method for managing the internet business cards may further include providing one or more of information pieces about the users to a SNS server in response to a search query sent from the SNS server, without limitation of the security level, wherein the SNS server is a server having security certification completed for the business card database.

The method for managing the internet business cards may further include receiving a search query for another user's internet business card from one of the users; determining whether a link is formed between the one user's internet business card and another user's internet business card; and displaying another user's internet business card to the one of the users based on the result of the determination.

The method for managing the internet business cards may further include sensing a renewal event for an internet business card corresponding to one of the users; and noticing the renewal event for the one user's business card to other users whose business cards are linked with the one user's business card according to the sensed renewal event.

The method for managing the internet business cards may further include sending information about one of the users provided in the application for a paper business card to a system for producing paper business cards, in response to an application for producing a paper business card received from one of the users; and producing the one user's internet business card, using the information stored in the business card database.

The method for managing the internet business cards may further include determining whether the internet business card needs updating, when the one user's internet business card is generated already; and sending updated information about the one user to the business card database, when the updating is needed based on the result of the determination.

The method for managing the internet business cards may further include generating the one user's mobile business card, using the information stored in the business card database; and receiving selection of a communication gesture for the one user through an application of the mobile business card installed in a user terminal, as a QR code generated based on the information stored in the business card database is scanned.

In the receiving the selection of the communication gesture for the one user, the selection of the communication gesture for the one user may be received, without releasing information about the one user from the application of the mobile business card.

The communication gesture may include one or more of wireless call connecting, wire call connecting, e-mail sending, SMS sending, message transmitting and conversation attempts.

The method for managing the internet business cards may further include generating virtual information corresponding to the one or more of the information pieces not to release the one or more of the information pieces; storing the virtual information after mapped with the one or more of the information pieces; and providing the mapped virtual information in response to a search query for the one or more of the information pieces.

In another aspect, the exemplary embodiments of the disclosure may provide a system for managing internet business cards including a business card database for storing internet business cards comprising one or more of users' names, addresses, contact information, e-mail addresses and home page addresses; a link forming unit for forming a link between the first user's internet business card and the second user's business card in response to the generated business card exchange event; a display unit for displaying a corresponding user's internet business card in response to the first user's or second user's search query the business card.

The system for managing the internet business cards may further include a searching unit for searching the second user's updated business card on the business card database, when the first user asks to search for the second user's internet business card, wherein the display unit displays the second user's updated internet business card to the first user based on the search result.

The system for managing the internet business cards may further include a security level setting unit for setting a security level for a link formed between internet business cards corresponding to each two of the users.

The system for managing the internet business cards may further include a search query receiving unit for receiving a search query for another user's internet business card from one of the users; and a determining unit for determining whether a link is formed between the one user's internet business card and another user's internet business card, wherein the display unit displays another user's internet business card to the one of the users based on the result of the determination.

The system for managing the internet business cards may further include a sensing unit for sensing a renewal event for an internet business card corresponding to one of the users; and a notice unit for noticing the renewal event for the one user's business card to other users whose business cards are linked with the one user's business card according to the sensed renewal event.

### ADVANTAGEOUS EFFECTS

According to the embodiments of the present disclosure, exemplary embodiments of the present disclosure provide a method and a system for managing business cards which can maintain human networking constantly by forming a link between internet business cards exchanged between users and providing another user's internet business card requested by a user in response to a user's business card search query.

Furthermore, exemplary embodiments of the present disclosure also provide a method and a system for managing business cards which can overcome the limitations of such the conventional paper business cards by producing an internet business card or mobile business card in response to a query made by a user to produce paper business cards automatically.

### BRIEF DESCRIPTION OF THE DRAWINGS

FIG. 1 is a diagram illustrating that a network is formed between users by a link formed according to users' exchanging internet business cards generated by a system for managing internet business cards according to exemplary embodiments of the disclosure;

FIG. 2 is a flow chart illustrating a method for managing internet business cards according to exemplary embodiments of the disclosure;

FIG. 3 is a flow chart illustrating another method for managing internet business cards according to exemplary embodiments of the disclosure;

FIG. 4 is a diagram illustrating a mobile business card and an internet business card generated by the method for managing the internet business cards according to the exemplary embodiments of the disclosure;

FIG. 5 is a diagram illustrating that an address book is displayed on a user's terminal via an application for mobile business cards according to exemplary embodiments of the disclosure and that selection of communication performance for the address book is implemented;

FIG. 6 is a flow chart illustrating a method for using virtual information generated corresponding to at least one piece of user information, in calling a chauffeur service; and

FIG. 7 is a block diagram of a system for managing internet business cards according to exemplary embodiments of the disclosure.

### BEST MODE

Exemplary embodiments of the disclosed subject matter are described more fully hereinafter with reference to the accompanying drawings. The disclosed subject matter may, however, be embodied in many different forms and should not be construed as limited to the exemplary embodiments set forth herein.

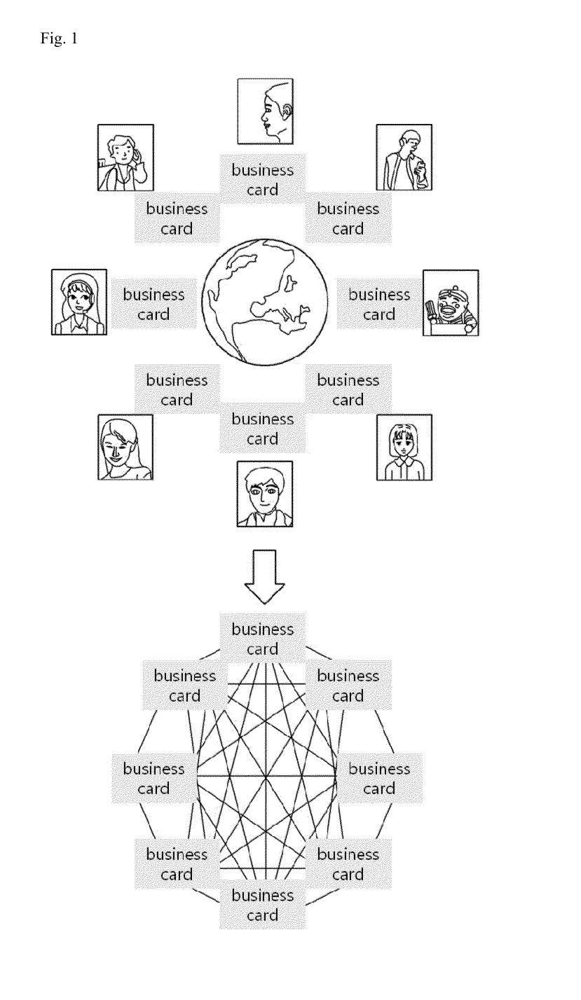

FIG. 1 is a diagram illustrating that a network is formed between users by a link formed according to users' exchanging internet business cards generated by a system for managing internet business cards according to exemplary embodiments of the disclosure.

As mentioned above, a conventional paper business card has the limitation according to renewal and loss and it is typical to lose the formed network, without constant management or direct contact even between people having exchanged business cards. However, there may be a network effect, in case the relation formed by the business card exchanging is networked. The network effect refers to the effect that the number of users for a product or a service affects the other or potential users.

Such the network effect is evidenced through Metcalfe's Law that a total value of a product or service having “network effect” is proportional to the square of the number of users.

Accordingly, one embodiment may provide a method and a system for managing internet business cards which can network a personnel network relation formed by actual business exchange with a link between users having exchanged internet business cards. In the system for managing the internet business cards according to the embodiment, a network platform which reflects relations in a real world directly and the network platform grows after formed.

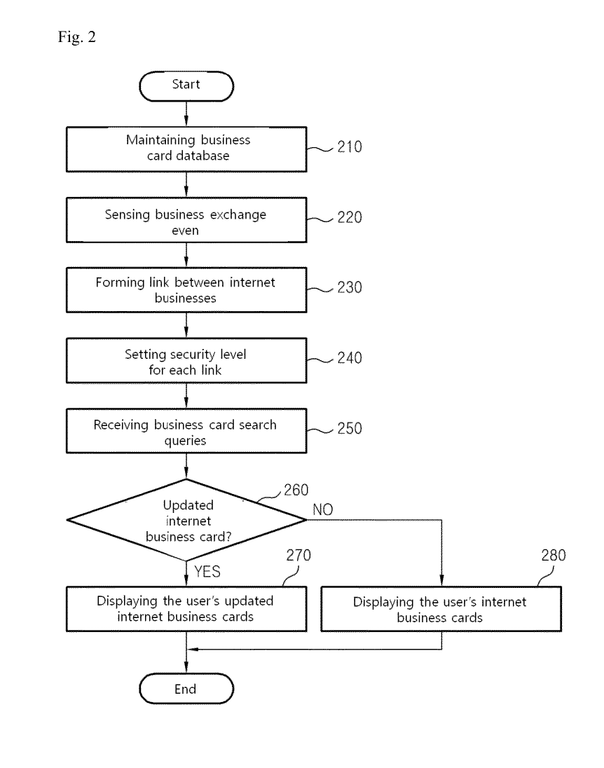

FIG. 2 is a flow chart illustrating a method for managing internet business cards according to exemplary embodiments of the disclosure.

The system for managing the internet business cards maintains a business card database (210). In the business card database may be stored internet business cards for users and each of the internet business cards contains one or more of the corresponding user's name, address, contact list, e-mail address and home page.

The system for managing the internet business cards may sense that a business card exchange event is generated between a first user and a second user of the users (220) and forms a link between the first user's internet business card and the second user's internet business card in response to the generated business card exchange event (230). The first and second users mean the users who have exchanged their internet business cards. The business card exchange event means a gesture performed by one user who exchanges internet business cards on the internet to form a personnel network with another user. In addition, the business card exchange event may mean various gestures configured to form a personnel network such as exchanging contact information.

The system for managing the internet business cards may set a unique security level for each of the links formed between two users' internet business cards among the users (240). The security level set for each of the links may mean a security level for releasing information about the two users for whom links are formed after the internet business cards are exchanged and the security level may be determined by the user's selection or the setting performed by the system for managing the internet business card.

The system for managing the internet business cards may select one or more of information pieces which will be released according to the security level set in the step (240) for each of the users and provide the selected one or more pieces of the information to the users whose internet business cards the link is formed between.

For example, the system for managing the internet business cards may set the security level for the first user as a first level and the security level for the second user as a second level for the link formed between the first user's internet business card and the second user's internet business card. It is assumed that the information selected to be released at the first security level be the user's name and photograph and that the information selected to be released at the second security level be the user's name, photograph and phone number.

In case of the first user, only the name and photograph is released to the second user out of the information pieces including the first user's name, address, contact list, e-mail address and home page address. In case of the second user, only the name, photograph and phone number are released to the first user.

If setting the security levels for the information which will be released to the users, whose internet business cards the link is formed between, as the same levels, the system for managing the internet business cards may adjust the security levels to be a higher or lower security level than the unique security level under the users' consent properly.

Specifically, the information which will be released between the users whose internet business cards are exchanged only to form the link may be the 1:1 independent, individual and identical type of information. Also, it can be said that the information which will be released between the users whose internet business cards are exchanged only to form the link is exclusive information in an aspect that it is set not released to the other users for whom the link is not formed.

Moreover, the system for managing the internet business cards may provide an SNS server with one or more pieces of information about the users in response to a search query transmitted from a SNS (Social Networking Service) server. At this time, the system for managing the internet business cards may provide the SNS server with one or more pieces of the information about the users, with no limitation on the security level, which is different from the information released between the users. The SNS server is the server having security certification completed.

The system for managing the internet business cards may receive a search query corresponding to the first and second users' internet business cards (250) and search the users' updated internet business cards on a business card database (260).

When the second user's updated internet business card is searched on the business card database based on the search result of the step (260), the system for managing the internet business cards may display the second user's updated internet business card to the first user (270).

If the second user's updated business card is not searched on the business card database, the system for managing the internet business cards may display the second user's existing business card to the first user (280).

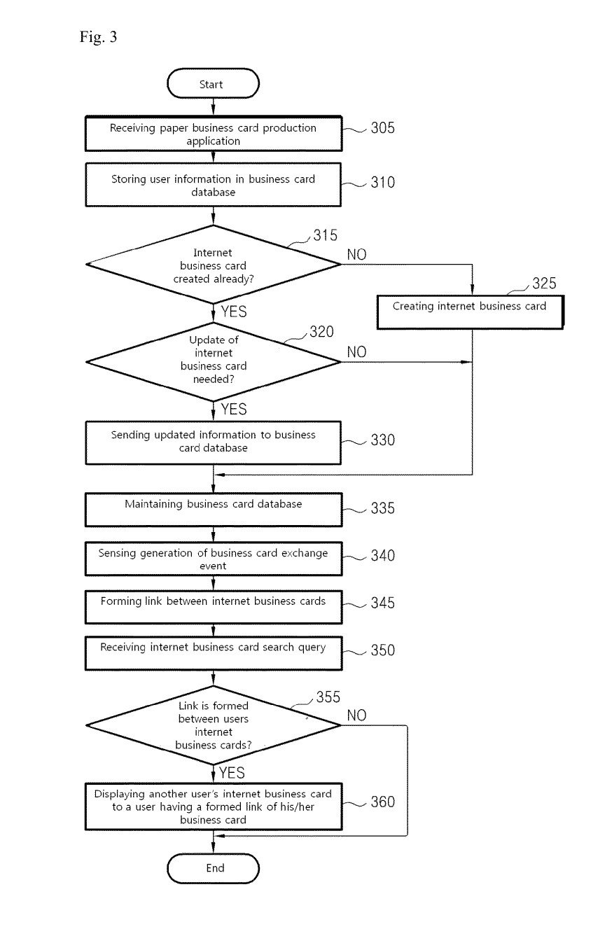

FIG. 3 is a flow chart illustrating another method for managing internet business cards according to exemplary embodiments of the disclosure.

The system for managing the internet business cards may receive an application for producing a paper business card from one of the users (305) and store the information about the user in the business card database (310).

At this time, the system for managing the internet business cards may transmit the one user's information provided in the paper business card producing application to a system for producing paper business cards. The system for producing the paper business cards may produce a paper business card for the corresponding user based on the information about the user.

The system for managing the internet business cards may determine whether the corresponding user's internet business card is already created, before creating the corresponding user's internet business card, using the information stored in the business card database (315).

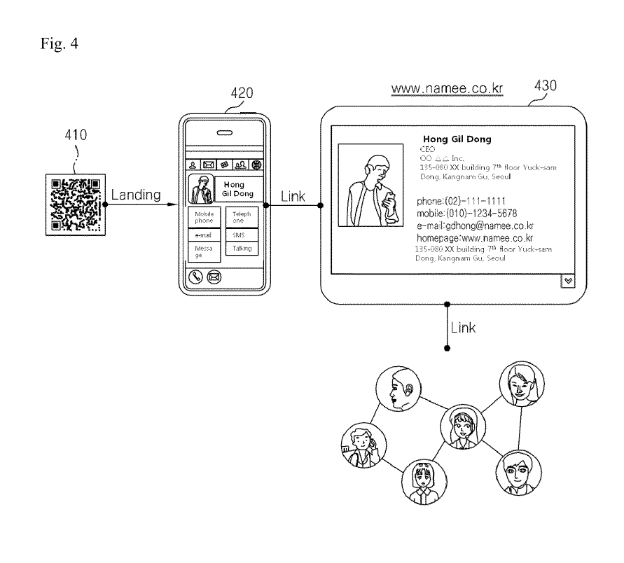

When the corresponding user's internet business card is not generated yet based on the result of the step (315), the system for managing the internet business cards may generate an internet business card for the corresponding user (325) and maintain the generated internet business card (335). The internet business card generated in the system for managing the internet business cards will be described, referring to FIG. 4.

In contrast, when it is determined in the step (315) that the internet business card for the one of the users is already generated, the system for managing the internet business cards may determine whether the internet business card for the corresponding user needs updating (320).

When the internet business card for the corresponding user needs updating based on the result of the determination in the step (320), the system for managing the internet business cards may transmit the updated information about the corresponding one of the users to the business card database (330). In the business card database may be stored the updated information about the corresponding one of the users

In contrast, when the internet business card for the corresponding user does not need updating based on the result of the step (320), the system for managing the internet business cards may maintain the business card database continuously (335). In the business card database may be stored one or more information of the users' names, addresses, contact lists, e-main addresses and home page addresses.

The system for managing the internet business cards may sense that a renewal event of an internet business card for one of the users and notice to a user whose internet business card forms a link with the one of the users that a renewal for the corresponding user's internet business card is generated according to the sensed renewal event.

The system for managing the internet business cards may sense a business card exchange event between two of the users (e.g., a first user and a second user) (340) and form a link between the users' (e.g., the first and second users') business cards (345).

After that, the system for managing the internet business cards may receive a search query for the other one's internet business card from one of the users (350) and determine whether a link is formed between an internet business card for the one and an internet business card for the other one (355).

If the link is formed between the one's internet business card and the other one's internet business card based on the result of the determination in the step (355), the system for managing the internet business cards may display the other one's internet business card to the one of the users (360). If no link is formed between the one's internet business card and the other one's internet business card based on the result of the determination in the step (355), the system for managing the internet business cards may end the operation without displaying the other one's internet business card.

FIG. 4 is a diagram illustrating a mobile business card and an internet business card generated by the method for managing the internet business cards according to the exemplary embodiments of the disclosure.

The system for managing the internet business cards may generate a mobile business card or an internet business card for one of the users, using the information stored in the business card database.

The information stored in the business card database may be the information about one of the users provided in an application for producing a paper business card or the information stored via a separated passage. In the business card database may be stored internet business cards having one or more of the users' names, addresses, contact list, e-mail addresses and home page addresses.

The system for managing the internet business cards may generate a QR code 410 based on the information stored in the business card database (410) and print the generated QR code 410 on one of the user's paper business card.

The QR code 410 printed on the one user's paper business card may scan the user's terminal (e.g., a smart phone) and an application of a mobile business card 420 may be installed in the user terminal as the QR code 410 is scanned.

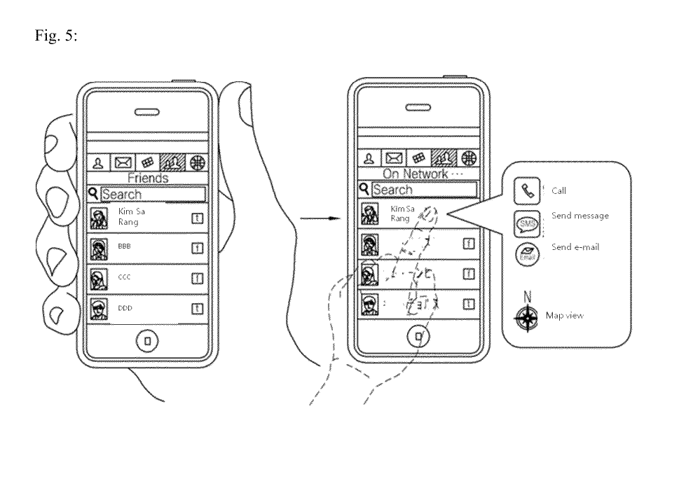

In other words, a mobile business card 420 only for one of users is provided in a user terminal and the mobile business card 420 may perform a role of a landing page for a QR code printed on a paper business card. At this time, the user may perform a communication gesture such as calling, sending a message and sensing an e-mail through an address book generated by the application. Hereinafter, a method for selecting a communication gesture for one of the users through the application of the mobile business card 420 installed in the user terminal will be described, referring to FIG. 5.

The system for managing the internet business cards may generate an internet business card 430 for one of users, using the information stored in the business card database. The internet business card 430 may be a blog type business card containing contact list information and it may be linked with internet business cards for people exchanging internet business cards with the user. At this time, links with the users' internet business cards are formed in response to a business card exchange event between two of the users. Also, a link is formed between internet business cards for all of the people exchanged business cards with one of the users.

Of course, a link between the internet business card 430 and an application of the mobile business card 420 may be formed. A home page of a company, a personal blog or SNS may be in communication with the user's internet business card.

FIG. 5 is a diagram illustrating that an address book is displayed on a user's terminal via an application for mobile business cards according to exemplary embodiments of the disclosure and that selection of communication performance for the address book is implemented.

On the user terminal may be displayed an address book shown in an upper portion of FIG. 5 may be displayed through the application of the mobile business card mentioned above. The address book displayed on the user terminal may provide only the limited information of the user's name and photograph. Actual information of the user's address, contact list, e-mail address or home page address may not be provided.

The user may input selection of a communication gesture for one of the users displayed on the address book through the application of the mobile business card as shown in a lower portion of FIG. 5. At this time, the application of the mobile business card may receive an input for selecting a communication gesture of one of the users, even without releasing information about one user which is an object of the communication.

The communication gesture for one of the users may include one or more of wireless phone connecting, wire telephone connecting, e-mail sending, SMS sending, texture message sensing, note delivering, residence identifying and an attempt for conversation.

Accordingly, a user trying to call one of the other users may select an icon of call and perform call connection, even without releasing an actual telephone number of one of the other users. The user trying to send a mail to one of the users or to figure out an address corresponding to one of the users may select an icon for mail sending or an icon for a map of an address to send a mail to an actual mail address corresponding to one of the users or figure out an address through a location mark displayed on a map. Gestures performed in FIG. 5 may be performed on an internet business card as well as on the application of the mobile business card mentioned above.

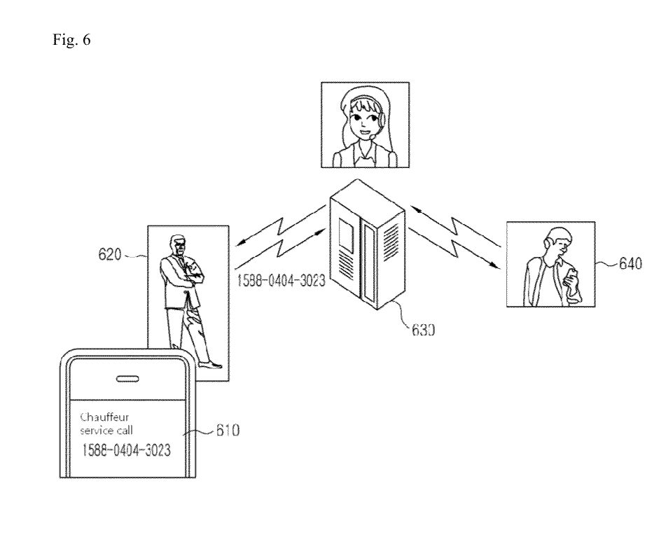

FIG. 6 is a flow chart illustrating a method for using virtual information generated corresponding to at least one piece of user information, in calling a chauffeur service.

Generally, a user experiences spam message reception and telemarketing call reception inconveniently as his or her mobile phone number is released. Accordingly, in this embodiment, a virtual information piece is generated corresponding to one or more pieces of information about the user and the generated virtual information is used in preventing the user's mobile phone number from being released to a unspecified person.

A typical route of the user's mobile phone number release to unspecified people is the user's mobile phone number placed in a vehicle possessed by the user or a chauffeur service call.

Hereinafter, a method for using a chauffeur service, even without releasing a user's mobile phone number according to the exemplary embodiments of the disclosure will be described.

A system for managing internet business cards 630 may generate virtual information 610 corresponding to one or more pieces of information about users 640 not to release the information about the users 640. The generated virtual information 610 may be mapped with one or more pieces of the information and stored in a business card database. The system for managing the internet business cards 630 may generate virtual information corresponding to each of the users 640 (e.g., one virtual number corresponding to the user's membership members) and virtual information pieces corresponding to one or more pieces of virtual information about the users (e.g., the users' names, phone numbers and e-mail addresses), respectively.

After that, the system for managing the internet business cards 630 may provide the virtual information 610 mapped with one or more of the information in response to a query for one or more of the information received from the users 640.

The system for managing the internet business cards 630 may allow the users 640 to use a chauffeur service without releasing the information about them, using the generated virtual information 610.

When one of the users 640 whose information (or an internet business card) is stored in the business card database The system for managing the internet business cards 630 makes a call to a chauffeur service company 620, the system for managing the internet business cards 630 connect a call to the chauffeur service company manually. At this time, it is assumed that the phone number provided by the system for managing internet business card 630 is “1588-4040” and that the membership numbers for the user calling the chauffeur service is “0925”.

When the user 640 makes a call to 1588-4040 for the chauffeur service company 620, the system for managing the internet business cards 630 may provide the virtual information 610 mapped corresponding to the user's membership numbers (1588-4040-3023) to the chauffeur service company 620.

The numbers of “1588-4040-3023” (in other words, virtual numbers 610) sent to the chauffeur service company 620 from a corresponding client (specifically, the system for managing the internet business cards 630 provided in the user terminal possessed by the user, when the company is calling the user 640) may be automatically connected to the user 640. Accordingly, the user 640 may use the desiring service, even without releasing the actual mobile phone number. After generated by the user's query, the virtual information 610 may be set effective only for a preset time period (e.g., for 3 hours) and the preset time period may be changed by the system for managing the internet business cards 630 or the user's selection.

Moreover, the system for managing the internet business cards may provide virtual numbers used as the user's contact number placed in a vehicle.

For example, it can be assumed that the phone number provided by the system for managing the internet business cards as virtual numbers for the user is “1588-4040” and that a code for a phone purpose corresponding to a query for moving a vehicle is “I” and a code for the user (membership numbers for the user) is “0925”.

At this time, the virtual numbers provided to the user by the system for managing the internet business cards may be “1588-4040-10925”. When a person asking the user to move a car may call the contact number placed in the user's car, in other words, the virtual number of “1588-4040-10925”, the system for managing the internet business cards may put the call through the user's contact number mapped with the corresponding virtual number or provide texture message to the user's mobile phone.

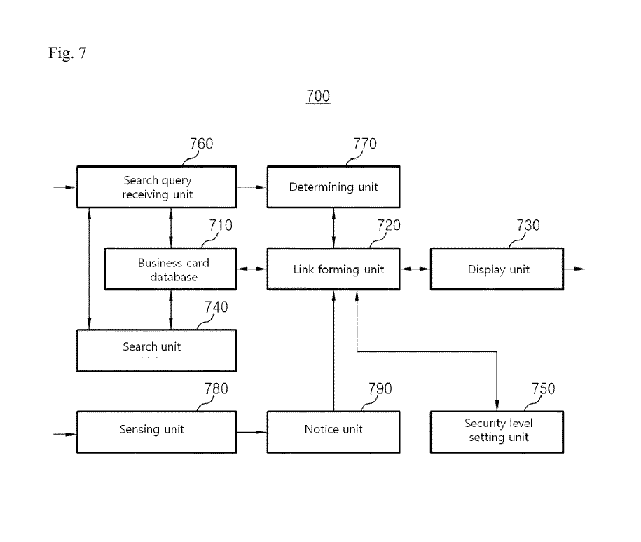

FIG. 7 is a block diagram of a system for managing internet business cards according to exemplary embodiments of the disclosure.

A system for managing internet business cards 700 according to exemplary embodiments of the disclosure includes a business card database 710, a link forming unit 720 and a display unit 730. The system for managing the internet business cards 700 according to the exemplary embodiments may further include a search unit 740, a security level setting unit 750, a search query receiving unit 760, a determining unit 770, a sensing unit 780 and a notice unit 790.

In the business card database 710 may be stored internet users' business cards including one or more of the users' names, addresses, e-mail addresses and home page addresses.

The link forming unit 710 may form a link between a first user's internet business card and a second user's internet business card in respect to a business card exchange event between a first user and a second user out of the users.

The display unit 730 may display the user's internet business card corresponding to a business card search query in response to the first or second user's business card search query.

When the first user generates a query for the second user's internet business card, the search unit 740 may search the second user's updated internet business card on the business card database. At this time, the display unit 730 may display the second user's updated business card to the first user based on the result of the search.

The security level setting unit 750 may set a security level for each link formed between internet business cards corresponding to two of the users.

The search query receiving 760 may receive a search query for another user's internet business card from one of the users.

The determining unit 770 may determine whether a link is formed between the one user's internet business card and the other user's business card.

At this time, the display unit 730 may display the other user's internet business card to the one user based on the result of the determination.

The sensing unit 780 may sense a renewal event for the one user's internet business card.

The notice unit 790 may notice to other users whose internet business cards are linked with the one user's internet business card that the renewal event for the one user's internet business card is generated.

The methods mentioned hereinabove may be realized as program commands implemented through various computing means and recorded in a computer readable media. The computer readable media may include a program command, a data file, a data structure or combination of them. The program command recorded in the medium may be configured for exemplary embodiments of the disclosure. Examples of computer readable medium include magnetic medium such as a hard disk, a floppy disk, optical medium such as CD-ROM and DVD, magneto-optical medium such as a floptical disk, and a hardware device such as ROM, RAM, and a flash memory. The hardware device may be configured to execute one or more software modules to implement the exemplary embodiments. Examples of the program commands may include a mechanical language code made by a compiler and a high level language code implementable by a computer, using an interpreter, and the like. The hardware device may be configured to execute one or more software modules to implement the exemplary embodiments.

Various variations and modifications of the refrigerator described above are possible in the component parts and/or arrangements of the subject combination arrangement within the scope of the disclosure, the drawings and the appended claims.

In addition to variations and modifications in the component parts and/or arrangements, alternative uses will also be apparent to those skilled in the art.

What is claimed is:

1. A method for managing internet business cards comprising:
maintaining a business card database in which internet business cards including one or more of users' names, addresses, contact information, e-mail addresses and home page addresses;
sensing a business card exchange event generated between a first user and a second user out of the users;
forming a link between the first user's internet business card and the second user's business card in response to the generated business card exchange event; and
displaying a corresponding user's internet business card in response to the first user's or second user's search query the business card.

2. The method for managing the internet business cards of claim 1, further comprising:
searching the second user's updated business card on the business card database, when the first user asks to search for the second user's internet business card; and
displaying the second user's updated internet business card to the first user based on the search result.

3. The method for managing the internet business cards of claim 1, further comprising:
setting a security level for a link formed between internet business cards corresponding to each two of the users.

4. The method for managing the internet business cards of claim 3, further comprising:
selecting one or more of information pieces which will be released according to the set security level; and
providing the selected information to users whose internet business cards are linked with each other.

5. The method for managing the internet business cards of claim 3, further comprising:
providing one or more of information pieces about the users to a SNS server in response to a search query sent from the SNS server, without limitation of the security level,
wherein the SNS server is a server having security certification completed for the business card database.

6. The method for managing the internet business cards of claim 1, further comprising:
receiving a search query for another user's internet business card from one of the users;
determining whether a link is formed between the one user's internet business card and another user's internet business card; and
displaying another user's internet business card to the one of the users based on the result of the determination.

7. The method for managing the internet business cards of claim 1, further comprising:
sensing a renewal event for an internet business card corresponding to one of the users; and
noticing the renewal event for the one user's business card to other users whose business cards are linked with the one user's business card according to the sensed renewal event.

8. The method for managing the internet business cards of claim 1, further comprising:
sending information about one of the users provided in the application for a paper business card to a system for producing paper business cards, in response to an application for producing a paper business card received from one of the users; and
producing the one user's internet business card, using the information stored in the business card database.

9. The method for managing the internet business cards of claim 8, further comprising:
determining whether the internet business card needs updating, when the one user's internet business card is generated already; and
sending updated information about the one user to the business card database, when the updating is needed based on the result of the determination.

10. The method for managing the internet business cards of claim 8, further comprising:
generating the one user's mobile business card, using the information stored in the business card database; and
receiving selection of a communication gesture for the one user through an application of the mobile business card installed in a user terminal, as a QR code generated based on the information stored in the business card database is scanned.

11. The method for managing the internet business cards of claim 10, wherein in the receiving the selection of the communication gesture for the one user, the selection of the communication gesture for the one user is received, without releasing information about the one user from the application of the mobile business card.

12. The method for managing the internet business cards of claim 11, wherein the communication gesture comprises one or more of wireless call connecting, wire call connecting, e-mail sending, SMS sending, message transmitting and conversation attempts.

13. The method for managing the internet business cards of claim 1, further comprising:
generating virtual information corresponding to the one or more of the information pieces not to release the one or more of the information pieces;
storing the virtual information after mapped with the one or more of the information pieces; and
providing the mapped virtual information in response to a search query for the one or more of the information pieces.

14. A computer readable media in which a program for implementing the method according to one of claims 1 through 13 is recorded.

15. A system for managing internet business cards comprising:
a business card database for storing internet business cards comprising one or more of users' names, addresses, contact information, e-mail addresses and home page addresses;
a link forming unit for forming a link between the first user's internet business card and the second user's business card in response to the generated business card exchange event; and
a display unit for displaying a corresponding user's internet business card in response to the first user's or second user's search query the business card.

16. The system for managing the internet business cards of claim 15, further comprising:
a searching unit for searching the second user's updated business card on the business card database, when the first user asks to search for the second user's internet business card,
wherein the display unit displays the second user's updated internet business card to the first user based on the search result.

17. The system for managing the internet business cards of claim 15, further comprising:
a security level setting unit for setting a security level for a link formed between internet business cards corresponding to each two of the users.

18. The system for managing the internet business cards of claim 15, further comprising:
a search query receiving unit for receiving a search query for another user's internet business card from one of the users; and
a determining unit for determining whether a link is formed between the one user's internet business card and another user's internet business card,
wherein the display unit displays another user's internet business card to the one of the users based on the result of the determination.

19. The system for managing the internet business cards of claim 1, further comprising:
a sensing unit for sensing a renewal event for an internet business card corresponding to one of the users; and
a notice unit for noticing the renewal event for the one user's business card to other users whose business cards are linked with the one user's business card according to the sensed renewal event.
